(19) United States
(12) Patent Application Publication
(10) Pub. No.: US 2026/0336711 A1
(43) Pub. Date: Oct. 29, 2026

(54) VEHICLE AND ROOF

(71) Applicant: KAWASAKI MOTORS, LTD., Akashi-shi (JP)

(72) Inventor: Justin OLSON, Lincoln, NE (US)

(73) Assignee: KAWASAKI MOTORS, LTD., Akashi-shi (JP)

(21) Appl. No.: 19/434,297

(22) Filed: Dec. 29, 2025

Related U.S. Application Data
(60) Provisional application No. 63/743,296, filed on Jan. 9, 2025.

(51) Int. Cl. B62D 25/06; B60N 2/01; B60R 7/04

(52) U.S. Cl. CPC B62D 25/06; B60N 2/01; B60R 7/04

(57) ABSTRACT

A vehicle includes a pillar extending upward in a vehicle body, and a roof supported at a top of the pillar. The roof includes an upper surface and a lower surface. The lower surface of the roof includes a main surface, and a locator or guide portion that protrudes downward from the main surface and locates or guides a storage. The locator or guide portion has a shape in which a horizontal cross section varies at least in part.

### CROSS-REFERENCE TO RELATED APPLICATION

The present application claims priority to U.S. Provisional Application No. 63/743,296 filed on Jan. 9, 2025, the content of which is incorporated herein by reference.

### TECHNICAL FIELD

This disclosure relates to a vehicle.

### BACKGROUND ART

U.S. Pat. No. 11,180,086 B2 discloses a vehicle including a roof with a storage.

### SUMMARY

This vehicle includes a pillar extending upward in a vehicle body and a roof supported at a top of the pillar, the roof including an upper surface and a lower surface The lower surface of the roof includes a main surface, and a guide that protrudes downward from the main surface and guides a storage. The guide portion has a shape in which a horizontal cross section varies at least in part.

In this vehicle, the storage is to be mounted to the lower surface of the roof.

The objects, features, aspects, and advantages of this disclosure will become more apparent from the following detailed description and the accompanying drawings.

### BRIEF DESCRIPTION OF THE DRAWINGS

FIG. 1 is a side view illustrating a vehicle.

FIG. 2 is a perspective view illustrating an upper portion of the vehicle.

FIG. 3 is a plan view illustrating a roof.

FIG. 4 is a perspective view illustrating the roof.

FIG. 5 is an enlarged view of a region R2 in FIG. 4.

FIG. 6 is an enlarged view of a region R1 in FIG. 4.

FIG. 7 is a cross-sectional view taken along the VII-VII line in FIG. 4.

FIG. 8 is a cross-sectional view taken along the VIII-VIII line in FIG. 4.

FIG. 9 is an enlarged view of a region R3 in FIG. 8.

### DESCRIPTION OF THE PREFERRED EMBODIMENTS

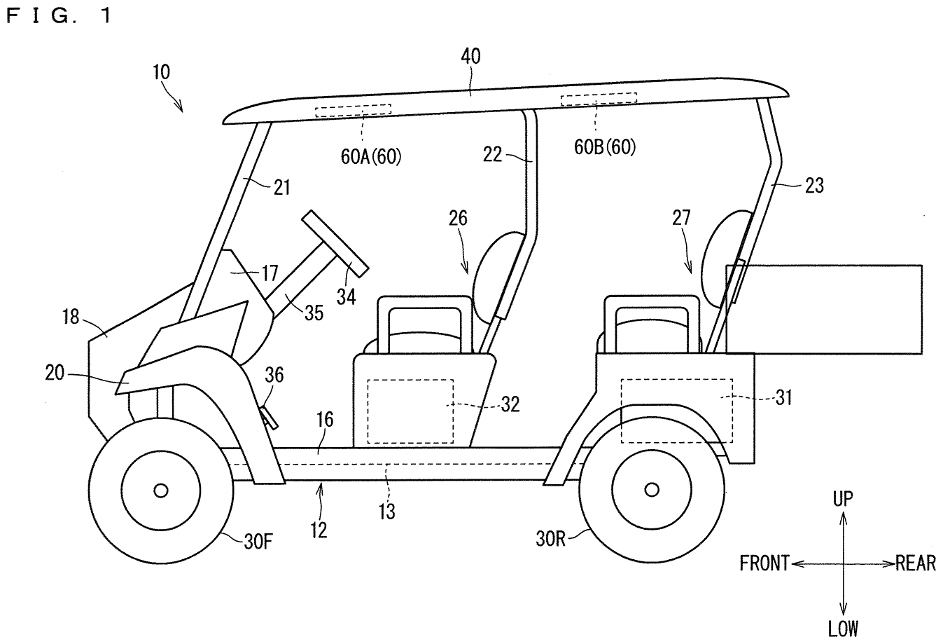

A vehicle according to an embodiment will be hereinafter described. FIG. 1 is a side view illustrating a vehicle 10. In the following description, a traveling direction of the vehicle 10 may be expressed as the front, the opposite direction may be expressed as the rear, a road surface side on which the vehicle 10 travels may be expressed as being low or down, and the opposite side may be expressed as being high or up. The right and left may be referred to while a person stands on a road surface and faces the front. A lateral direction is a vehicle-width direction. A side of a component refers to a position to the left or the right of the component.

The vehicle 10 may be a single-seater vehicle or a multi-seater vehicle. The vehicle 10 may have only a seat or seats in a forward and backward direction. Since the vehicle 10 is a vehicle designed to travel through, for example, private roads or private lands at low speeds, the vehicle 10 may have open right and left passenger entrances to seats without being obstructed by walls or doors to facilitate the occupant getting on or off the vehicle 10. Here, the occupant can walk past in the lateral direction without being obstructed by doors or walls.

### Overall Structure of Vehicle

The vehicle 10 includes a vehicle body 12 and a roof 40. The vehicle 10 includes a first seat 26, a second seat 27, a traveling mechanism, and a driving operation mechanism.

The vehicle body 12 may have a frame structure or a monocoque structure. This embodiment will be described assuming that the vehicle body 12 has a frame structure. The vehicle body 12 includes a vehicle body frame 13 and panels. The vehicle body frame 13 is structured by combining, for example, metallic pipe components, sheet metal components, or cast components. The panels cover the vehicle body frame 13 and various components supported by the vehicle body frame 13. The panels give the appearance of the vehicle 10, and partition spaces in the vehicle 10. Examples of the panels include a floor panel 16, a dashboard 17, a hood 18, and side panels 20.

The floor panel 16 is disposed under the occupant space in which a driver and an occupant are located. The dashboard 17 is disposed in a front end of the occupant space. The dashboard 17 functions as a partition that separates the occupant space from a front internal space located in front of the occupant space. The dashboard 17 may include an instrument panel, a glove box, various switches, and an indicator. The hood 18 is located in front of the dashboard 17. The hood 18 functions as a partition that partitions above the front internal space. The side panels 20 function as wheel houses of front wheels 30F.

Each of the first seat 26 and the second seat 27 is a part on which an occupant is to be seated. The first seat 26 and the second seat 27 are located above the floor panel 16. The vehicle body 12 supports the first seat 26 and the second seat 27. The first seat 26 and the second seat 27 are spaced from each other in the forward and backward direction. The first seat 26 is located in front of the second seat 27. Each of the first seat 26 and the second seat 27 includes a seat cushion, a back rest cushion, and a seat frame. The seat frames can be considered as parts of the vehicle body frame 13 in the vehicle body 12. Outside right and left portions of the first seat 26 and the second seat 27 are openings through which the occupant gets on and off the vehicle 10. The vehicle 10 is intended to normally travel with the openings being opened and not closed by, for examples, doors.

The first seat 26 and the second seat 27 are bench seats on which persons can be seated side by side in the vehicle-width direction. A driver seat on one side in the vehicle-width direction and a passenger seat on the other side in the vehicle-width direction are disposed to sandwich the middle in the vehicle-width direction. Here, a portion of the first seat 26 on one side with respect to the middle in the vehicle-width direction is considered as the driver seat, and a portion of the first seat 26 on the other side is considered as the passenger seat. The first seat 26 may have a structure in which the driver seat and the passenger seat are independently provided.

The traveling mechanism is a mechanism for traveling of the vehicle 10, and includes wheels 30F and 30R, a traveling motor 31, and a power transmission mechanism. Transmission of rotation drive force of the traveling motor 31 to the wheels 30F and 30R through the power transmission mechanism allows the vehicle 10 to travel. This embodiment describes an example in which the vehicle 10 includes the four wheels 30F and 30R. The vehicle 10 may include three or six wheels. The structure of the power transmission mechanism is discretionary. Examples of the power transmission mechanism may include a transmission and a drive shaft.

The wheels 30F and 30R include the front wheels 30F and rear wheels 30R. The two front wheels 30F are rotatable around its own central axis and are supported to be rotatable around a steering axis, at right and left front portions of the vehicle body 12. The two rear wheels 30R are supported to be rotatable around its own central axis at right and left rear portions of the vehicle body 12.

In this embodiment, the traveling motor 31 is an electric motor that converts electric energy into rotational motion for traveling. Here, the vehicle 10 includes a traveling battery 32 for supplying the electric energy to the traveling motor 31. For example, the traveling battery 32 is supported at a lower portion of the first seat 26, and the traveling motor 31 is supported at a lower portion of the second seat 27. The traveling motor 31 may be an internal combustion engine that burns fuel in a combustion chamber and generates power for traveling through expansion of gases from the burnt fuel. Here, the vehicle 10 should include a fuel tank. The positions of the traveling motor 31 and the traveling battery 32 are discretionary.

The driving operation mechanism is a mechanism for receiving a driving operation from the driver, and includes, for example, a steering wheel 34 and pedals 36. The operation of the steering wheel 34 by the driver enables the front wheels 30F to rotate around the steering axis. The driver can operate an accelerator and a brake through operations of the pedals 36. The steering wheel 34 and the pedals 36 are located in front of the first seat 26. The driver seated on the first seat 26 can operate the steering wheel 34 and the pedals 36. For example, a steering column 35 protrudes rearward from the dashboard 17, and the steering wheel 34 is supported at the end of the steering column 35. The pedals 36 are located below the steering wheel 34. The pedals 36 may be an accelerator pedal and a brake pedal that are separately provided. One pedal may operate both of the accelerator and the brake.

The vehicle body 12 includes pillars. The pillars extend upward in the vehicle body 12. The pillars herein include front pillars 21, center pillars 22, and rear pillars 23. The front pillars 21 extend upward in the vehicle body 12 from both sides of the dashboard 17. The center pillars 22 extend upward in the vehicle body 12 from the back rest of the first seat 26. The rear pillars 23 extend upward in the vehicle body 12 from behind the back rest of the second seat 27. The upper ends of the pillars may be connected through cross portions. The center pillars 22 or the rear pillars 23 may extend from, for example, a floor portion except the first seat 26 and the second seat 27. The number of the pillars is discretionary. For example, the center pillars 22 may be omitted.

The roof 40 is supported at a top of the pillars 21, 22, and 23. The roof 40 spreads to cover the first seat 26 and the second seat 27 from the top, above the first seat 26 and the second seat 27. The roof 40 has a function of providing the occupant with, for example, a sunshade and a weather shield. The roof 40 may spread in the forward and backward direction from a position in front of the steering wheel 34 toward a position behind the back rest of the second seat 27. The roof 40 may spread to cover the whole of the first seat 26 and the second seat 27 in the lateral direction.

Storages 60 may be mounted to the roof 40. The vehicle 10 may include the storages 60 mounted on the roof 40. Here, the vehicle 10 includes the storages 60. Here, the vehicle 10 includes the two storages 60. One of the two storages 60 is a first-seat storage 60A, and the other is a second-seat storage 60B. The second-seat storage 60B is spaced from the first-seat storage 60A in the forward and backward direction. The single roof 40 supports the first-seat storage 60A and the second-seat storage 60B. Hereinafter, the first-seat storage 60A and the second-seat storage 60B which need not be distinguished from each other will be simply referred to as the storages 60. Here, the first-seat storage 60A and the second-seat storage 60B have the same shape. The first-seat storage 60A and the second-seat storage 60B basically have the same structures except their mounting positions. The first-seat storage 60A and the second-seat storage 60B may have different structures on, for example, shape and capacity.

The first-seat storage 60A is disposed at a position in which an occupant to be seated on the first seat 26 can take in and out an object. The first-seat storage 60A is located, for example, between the upper ends of the front pillars 21 and the upper ends of the center pillars 22 along the forward and backward direction. The first-seat storage 60A may be located in front of the back rest of the first seat 26 along the forward and backward direction. The first-seat storage 60A may be located in front of the seat cushion of the first seat 26 along the forward and backward direction. The first-seat storage 60A may be located above the floor in front of the first seat 26. The second-seat storage 60B is disposed at a position in which an occupant to be seated on the second seat 27 can take in and out an object. The second-seat storage 60B is located, for example, between the upper ends of the center pillars 22 and the upper ends of the rear pillars 23 along the forward and backward direction. The second-seat storage 60B may be located in front of the back rest of the second seat 27 along the forward and backward direction. The second-seat storage 60B may be located in front of the seat cushion of the second seat 27 along the forward and backward direction.

### Roof 40 and its Surrounding Portion

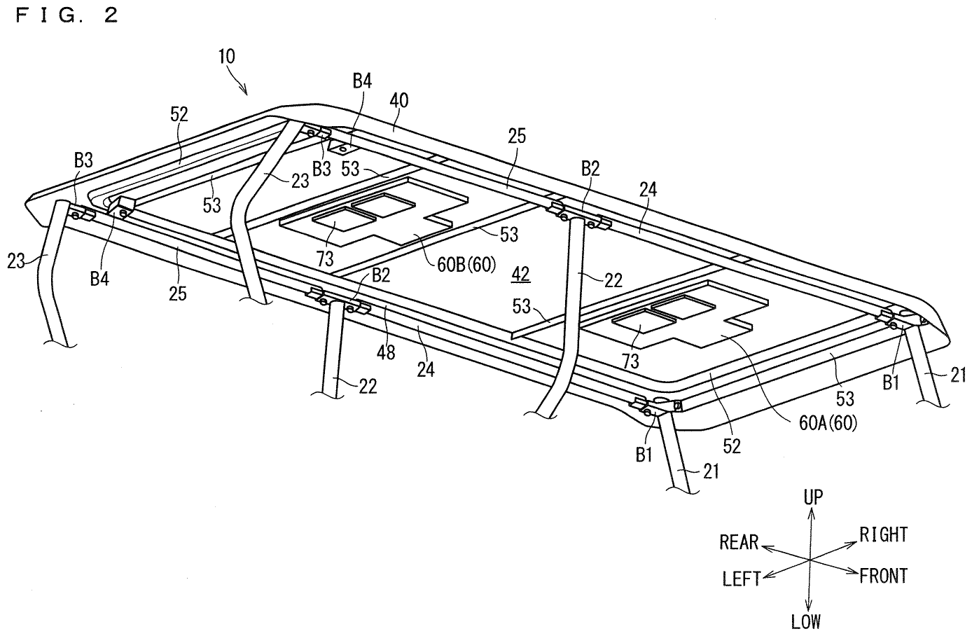

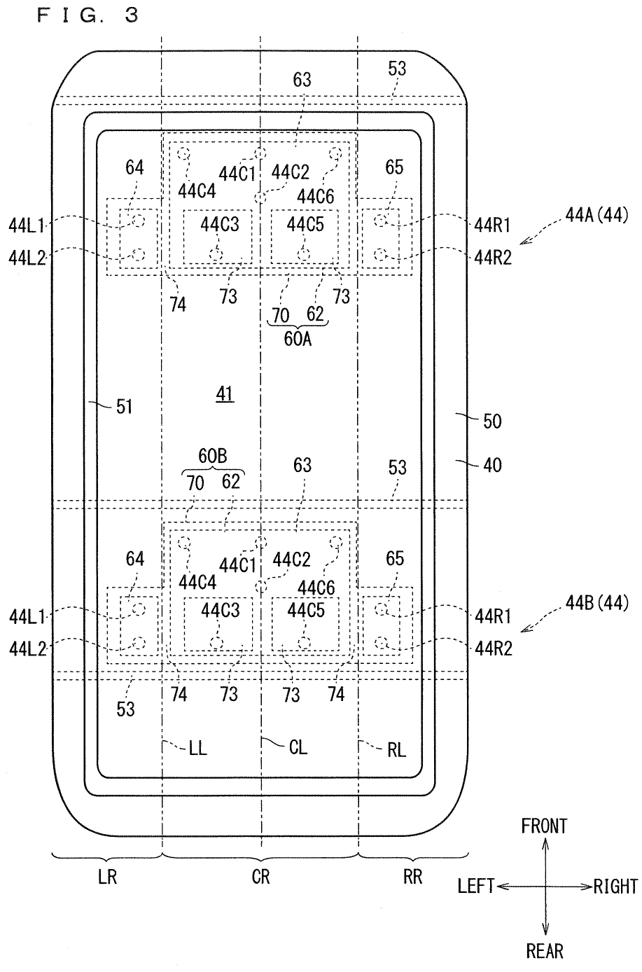

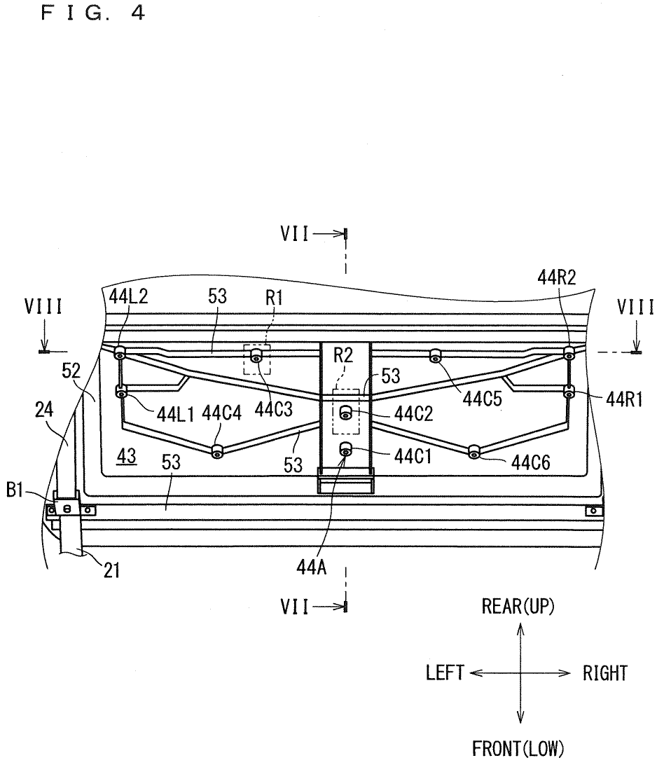

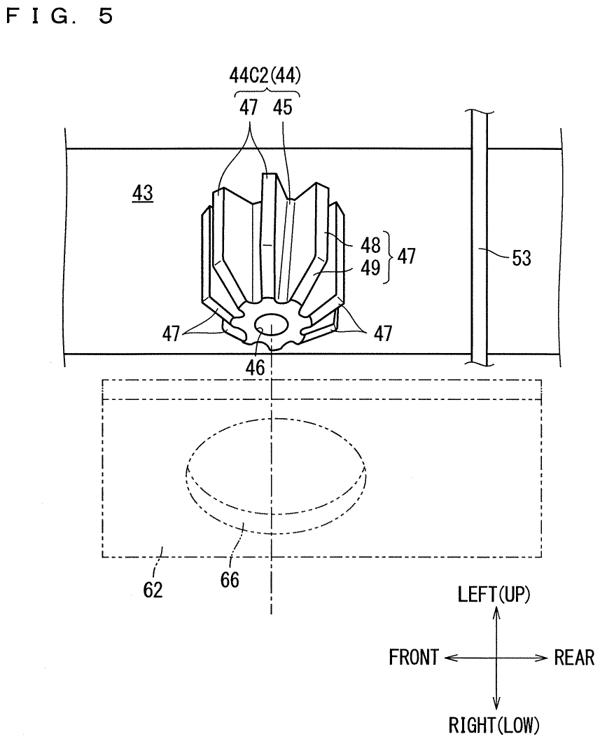

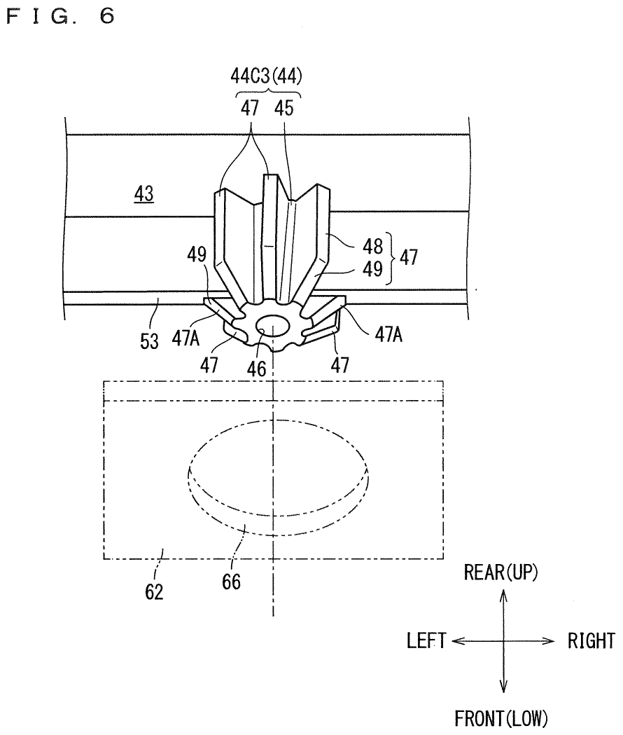

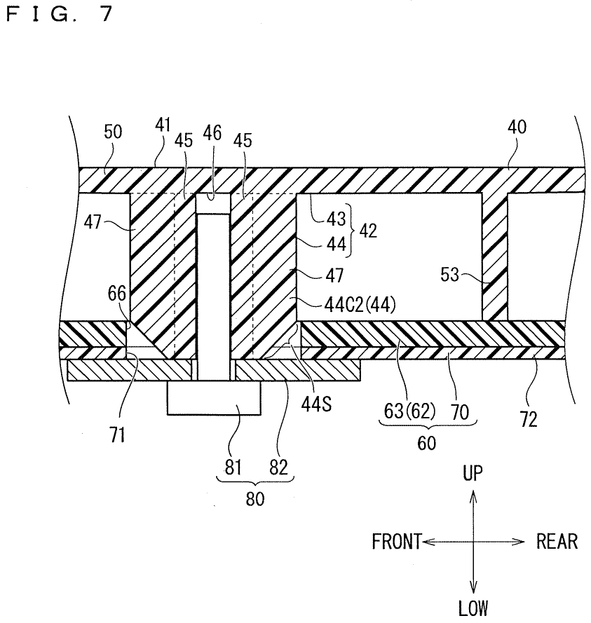

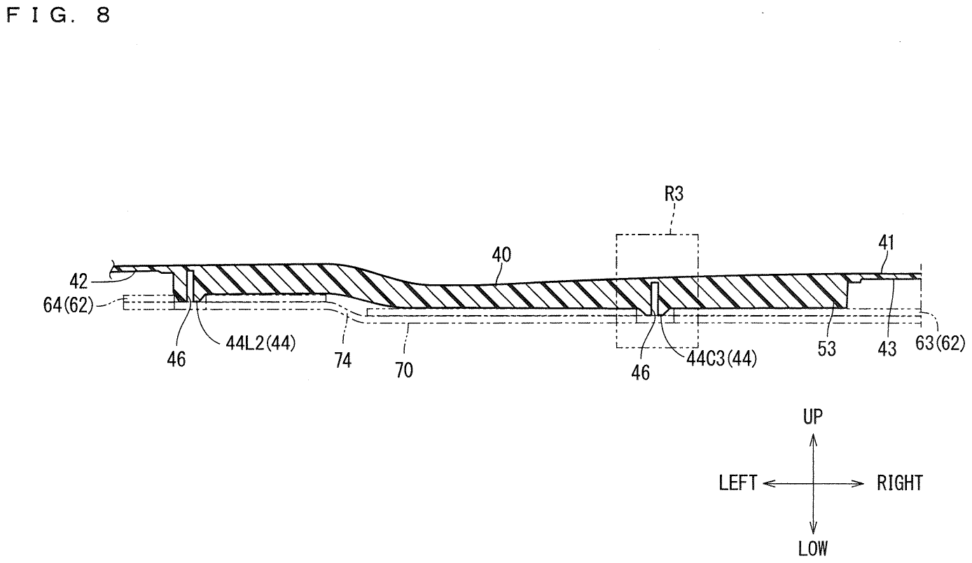

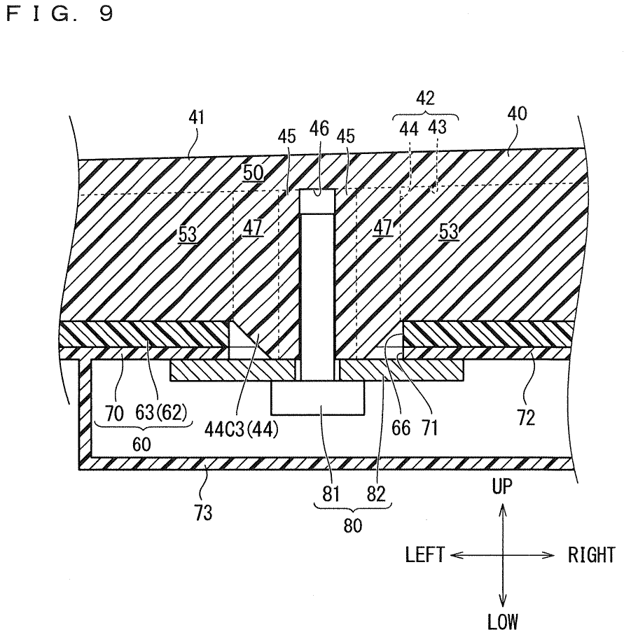

A structure of the roof 40 in the vehicle 10 will be described in detail. FIG. 2 is a perspective view illustrating an upper portion of the vehicle 10. FIG. 3 is a plan view illustrating the roof 40. FIG. 4 is a perspective view illustrating the roof 40. FIG. 5 is an enlarged view of a region R2 in FIG. 4. FIG. 6 is an enlarged view of a region R1 in FIG. 4. FIG. 7 is a cross-sectional view taken along the VII-VII line in FIG. 4. FIG. 8 is a cross-sectional view taken along the VIII-VIII line in FIG. 4. FIG. 9 is an enlarged view of a region R3 in FIG. 8.

The roof 40 includes an upper surface 41 and a lower surface 42. The upper surface 41 faces outward of the vehicle, and the lower surface 42 faces inward of the vehicle. The lower surface 42 faces the occupant space. The lower surface 42 includes a main surface 43 and positioning portions 44. The positioning portions 44 are also referred to as guide portions 44, or locators 44. Such locators can perform, if desired, a function of accurately positioning and constraining the storages 60. The positioning portions 44 protrude downward from the main surface 43. The positioning portions 44 are portions for positioning roof accessories to be mounted on the roof 40. The positioning portions herein are guide portions 44. The guide portions 44 protrude downward from the main surface 43. The guide portions 44 guide the storages 60. The storages 60 are mounted on the positions guided by the guide portions 44. For example, each of the storages 60 includes storage components that partition the accommodation space. In mounting the storage components, the guide portions 44 guide the storage components to position the storage components at predetermined mounting portions.

As illustrated in FIG. 2, the pillars 21, 22, and 23 support the lower surface 42 of the roof 40. Here, roof poles 24 and 25 are connected to the upper ends of the pillars 21, 22, and 23. The pillars 21, 22, and 23 and the roof poles 24 and 25 support the roof 40. The roof poles 24 and 25 extend in the forward and backward direction. A pair of the left and right roof poles 24 and a pair of the left and right roof poles 25 are provided. The roof poles 24 and 25 include front poles 24 and rear poles 25. The front ends of the front poles 24 are connected to the upper ends of the front pillars 21 through brackets B1. The rear ends of the front poles 24 and the front ends of the rear poles 25 are connected to the upper ends of the center pillars 22 through brackets B2. The rear ends of the rear poles 25 are connected to the upper ends of the rear pillars 23 through brackets B3. For example, the front portion of the roof 40 is connected to the brackets B1. The rear portion of the roof 40 is connected to brackets B4 extending from the rear poles 25. The lower surface 42 of the roof 40 includes connecting portions to be connected to the brackets B1 and B4.

The roof 40 herein includes a roof panel 50. The roof panel 50 is shaped into a plate spreading along a horizontal direction with almost the same thickness. Protrusions protrude downward from the roof panel 50. A portion of the roof panel 50 from which the protrusions do not protrude is the main surface 43 of the lower surface 42. The guide portions 44 are parts of the protrusions.

The roof 40 includes upstanding walls 53. The upstanding walls 53 are parts of the protrusions. The upstanding walls 53 extend in horizontal directions. One of the horizontal directions is an extension direction of each of the upstanding walls 53. The upstanding walls 53 are elongated in the extension directions. In the horizontal direction, a direction orthogonal to the extension direction is a thickness direction of the upstanding wall 53. For example, a dimension of the upstanding wall 53 in the thickness direction is smaller than a protruding dimension of the upstanding wall 53 from the roof panel 50.

A gutter 51 is formed on the upper surface 41 of the roof 40. The gutter 51 is, for example, a drainage pathway for draining well the water reaching the upper surface 41, such as rainwater. The gutter 51 is, for example, formed in a position slightly inward of the outer edge of the roof panel 50. The gutter 51 is continuously formed so as to make one round along the outer edge of the roof panel 50. An annular protrusion 52 corresponding to the gutter 51 is formed on the lower surface 42 of the roof 40. Similarly to the gutter 51, the annular protrusion 52 is also continuously formed so as to make one round along the outer edge of the roof panel 50. The annular protrusion 52 is a part of the protrusions. The roof poles 24 and 25 are located outward of the annular protrusion 52 along the vehicle-width direction. The guide portions 44 are located in a region enclosed by the annular protrusion 52. The guide portions 44 are spaced from each other. Specifically, the guide portions 44 are spaced from each other in the vehicle-width direction. For example, the guide portions 44 may be spaced from each other in the forward and backward direction.

As illustrated in FIG. 3, the roof 40 includes a first-seat guide portion 44A and a second-seat guide portion 44B. The first-seat guide portion 44A guides the first-seat storage 60A. The first-seat storage 60A is mounted on a position guided by the first-seat guide portion 44A. The second-seat guide portion 44B guides the second-seat storage 60B. The second-seat storage 60B is mounted on a position guided by the second-seat guide portion 44B. Hereinafter, the first-seat guide portion 44A and the second-seat guide portion 44B which need not be distinguished from each other will be simply referred to as the guide portions 44. Herein, the first-seat guide portion 44A and the second-seat guide portion 44B basically have the same structures except the positions on the roof 40.

Each of the first-seat guide portion 44A and the second-seat guide portion 44B includes center guide portions 44C1 to 44C6, left guide portions 44L1 and 44L2, and right guide portions 44R1 and 44R2. The center guide portions 44C1 to 44C6 are disposed in a center region CR along the vehicle-width direction. The left guide portions 44L1 and 44L2 are disposed in a left region LR with respect to the center region CR along the vehicle-width direction. The right guide portions 44R1 and 44R2 are disposed in a right region RR with respect to the center region CR along the vehicle-width direction.

In FIG. 3, a line CL is a center line CL passing through the center of the roof 40 along the vehicle-width direction. A line LL is a left line LL set to the left of the center line CL. A line RL is a right line RL set to the right of the center line CL. The center line CL, the left line LL, and the right line RL are virtual lines.

The center region CR is a region including the center line CL. The center region CR is, for example, a region between the left line LL and the right line RL. Furthermore, the left region LR is a region to the left of the left line LL, and the right region RR is a region to the right of the right line RL.

Locations of the left line LL and the right line RL can be, but not exclusively, appropriately set. Herein, the left line LL is set at the center between the center line CL and a left edge of the roof 40. The right line RL is set at the center between the center line CL and a right edge of the roof 40. The center region CR, the left region LR, and the right region RR may be division portions obtained by dividing the roof 40 into three along the vehicle-width direction.

Each of the first-seat guide portion 44A and the second-seat guide portion 44B includes at least one of the center guide portions 44C1 to 44C6. Here, each of the first-seat guide portion 44A and the second-seat guide portion 44B includes the center guide portions 44C1 to 44C6. The six center guide portions 44C1 to 44C6 are disposed symmetric with respect to the center line CL. The center line CL overlaps at least a part of the center guide portions 44C1 to 44C6. Here, the two center guide portions 44C1 and 44C2 are located at positions overlapping the center line CL. The two center guide portions 44C1 and 44C2 are aligned in the forward and backward direction.

The two center guide portions 44C3 and 44C4 are disposed to the left of the two center guide portions 44C1 and 44C2. The center guide portion 44C3 is located in the vicinity of the center between the center line CL and the left line LL in the vehicle-width direction. The center guide portion 44C4 is located to the left of the center guide portion 44C3. The center guide portion 44C4 is located closer to the left line LL than to the center line CL in the vehicle-width direction. The center guide portion 44C3 is located more rearward than the center guide portion 44C2 in the forward and backward direction. The center guide portion 44C4 is located in the same position as the center guide portion 44C1 in the forward and backward direction.

The two center guide portions 44C5 and 44C6 are disposed to the right of the two center guide portions 44C1 and 44C2. The center guide portion 44C5 is located in the vicinity of the center between the center line CL and the right line RL in the vehicle-width direction. The center guide portion 44C6 is located to the right of the center guide portion 44C5. The center guide portion 44C6 is located closer to the right line RL than to the center line CL in the vehicle-width direction. The center guide portion 44C5 is located more rearward than the center guide portion 44C2 in the forward and backward direction. The center guide portion 44C6 is located in the same position as the center guide portion 44C1 in the forward and backward direction.

The center guide portions 44C1 to 44C6 are disposed at different portions along the forward and backward direction. Herein, the center guide portions 44C1 to 44C6 are disposed at three different portions or more along the forward and backward direction. The center guide portions 44C1, 44C4, and 44C6 are disposed at the very front. The center guide portions 44C3 and 44C5 are disposed the most rearward. The center guide portion 44C2 is disposed between the center guide portions 44C1, 44C4, and 44C6 and the center guide portions 44C3 and 44C5.

The center guide portions 44C1 to 44C6 are disposed at different portions along the vehicle-width direction. Herein, the center guide portions 44C1 to 44C6 are disposed at three different portions or more along the vehicle-width direction. The center guide portion 44C4 is disposed at the leftmost. The center guide portion 44C6 is disposed at the rightmost. The center guide portions 44C1 and 44C2 are disposed at the center between the center guide portion 44C4 and the center guide portion 44C6. The center guide portion 44C3 is disposed between the center guide portion 44C4 and the center guide portions 44C1 and 44C2. The center guide portion 44C5 is disposed between the center guide portion 44C6 and the center guide portions 44C1 and 44C2.

Each of the first-seat guide portion 44A and the second-seat guide portion 44B includes at least one of the left guide portions 44L1 and 44L2. Here, each of the first-seat guide portion 44A and the second-seat guide portion 44B includes the two left guide portions 44L1 and 44L2. The two left guide portions 44L1 and 44L2 are disposed in the same position along the vehicle-width direction. The two left guide portions 44L1 and 44L2 are disposed separately along the forward and backward direction. The front left guide portion 44L1 is disposed between the center guide portion 44C2 and the center guide portion 44C3 along the forward and backward direction. The rear left guide portion 44L2 is disposed in the same position as the center guide portions 44C3 and 44C5 along the forward and backward direction.

Each of the first-seat guide portion 44A and the second-seat guide portion 44B includes at least one of the right guide portions 44R1 and 44R2. Here, each of the first-seat guide portion 44A and the second-seat guide portion 44B includes the two right guide portions 44R1 and 44R2. The two right guide portions 44R1 and 44R2 are disposed in the same position along the vehicle-width direction. The two right guide portions 44R1 and 44R2 are disposed separately along the forward and backward direction. The front right guide portion 44R1 is disposed between the center guide portion 44C2 and the center guide portion 44C3 along the forward and backward direction. The front right guide portion 44R1 is disposed in the same position as the left guide portion 44L1 along the forward and backward direction. The rear right guide portion 44R2 is disposed in the same position as the center guide portions 44C3 and 44C5 and the left guide portion 44L2 along the forward and backward direction.

Here, a part of the guide portions 44 are connected to the upstanding walls 53. A part of the guide portions 44 are disposed at positions away from the upstanding walls 53. Here, the two center guide portions 44C1 and 44C2 are disposed at the positions away from the upstanding walls 53. The guide portions 44C3 to 44C6, 44L1 and 44L2, and 44R1 and 44R2 except the two center guide portions 44C1 and 44C2 are connected to the upstanding walls 53.

FIG. 5 depicts the guide portion 44C2 as an example of the guide portion 44 disposed at a position away from the upstanding walls 53. As illustrated in FIG. 5, the guide portion 44C2 has a protruding shape. The guide portion 44C2 has a shape in which the horizontal cross section decreases toward the lower end. The guide portion 44C2 has, for example, a shape in which the horizontal cross section decreases from a middle portion in the forward and backward direction toward the lower end. The decrease in the horizontal cross section may be a decrease of an outside dimension in at least one direction vertical to the forward and backward direction as progressing downward. For example, the at least one direction may be any one of the forward and backward direction and the vehicle-width direction. The guide portion 44C2 is shaped into a cone whose contour decreases as progressing downward. The cone may be a pyramid, besides a circular cone or a circular truncated cone. Here, the guide portion 44C2 includes a column 45 and at least one rib 47.

The column 45 protrudes downward from the main surface 43. The column 45 may be a column whose dimension in the vertical direction is larger than its dimension in the horizontal direction. The column 45 is, for example, a cylindrical column or a prism. The ribs 47 protrude from the external surface (side surface) of the column 45 laterally (in the horizontal directions). The protruding directions of the ribs 47 are the horizontal directions. The ribs 47 protrude in the horizontal directions from a surface of the column 45 which faces the horizontal directions. Examples of the protruding directions of the ribs 47 may include radial directions of the column 45 and a direction orthogonal to a direction in which the column 45 extends.

The number of the ribs 47 may be one, two, or three or more. Here, the guide portion 44C2 includes the eight ribs 47. The eight ribs 47 radially extend from the column 45. The eight ribs 47 are spaced from each other in a circumferential direction of the column 45. Here, the eight ribs 47 are arranged at equal intervals. The eight ribs 47 extend in the radial directions of the column 45.

Each of the ribs 47 has a shape in which a protruding dimension of a portion from the column 45 toward the lower end decreases. The portion is located closer to an upper end than to the lower end of the rib 47. Here, protruding dimensions of upper portions 48 of the ribs 47 from the column 45 in the horizontal direction are uniform. Protruding dimensions of lower portions 49 of the ribs 47 from the column 45 toward the lower ends in the horizontal direction decrease. As illustrated in FIG. 7, the upper portion 48 of the rib 47 is, for example, rectangular. The lower portion 49 of the rib 47 is, for example, trapezoidal or triangular. The lower portion 49 of the rib 47 has a sloped surface. A lower portion of the guide portion 44 has a shape 44S in which a horizontal cross section varies at least in part. In this embodiment since the lower portion of the guide portion 44 includes the lower portions 49 of the ribs 47, the horizontal cross-sections of the shape 44S differ at all positions in the vertical direction.

FIG. 6 depicts the guide portion 44C3 as an example of the guide portion 44 connected to the upstanding walls 53. The guide portion 44C3 has the same structures as the guide portion 44C2 except that the guide portion 44C3 is connected to the upstanding walls 53. In the guide portion 44C3, a part of ribs 47A are integrally formed with the upstanding walls 53. The upper portions 48 of the ribs 47A are integrated into the upstanding walls 53. The lower portions 49 of the ribs 47A protrude downward from the upstanding walls 53.

The number of the ribs 47A integrated into the upstanding walls 53 is set, for example, according to the number of the upstanding walls 53 connected to the guide portion 44. The number of the ribs 47A integrated into the upstanding walls 53 may differ in each of the guide portions 44. The two upstanding walls 53 are connected to each of the guide portions 44C3 to 44C6. In each of the guide portions 44C3 to 44C6, the two ribs 47A are integrated into the upstanding walls 53. The three upstanding walls 53 are connected to each of the guide portions 44L1 and 44R1. In each of the guide portions 44L1 and 44R1, the three ribs 47A are integrated into the upstanding walls 53. The four upstanding walls 53 are connected to each of the guide portions 44L2 and 44R2. In each of the guide portions 44L2 and 44R2, the four ribs 47A are integrated into the upstanding walls 53.

The positions of the ribs 47A integrated into the upstanding walls 53 are set according to the arrangement of the upstanding walls 53. The positions of the ribs 47A integrated into the upstanding walls 53 may differ in each of the guide portions 44. For example, in the guide portions 44C3 and 44C4, the upstanding walls 53 extend to the left and the right of the guide portions 44C3 and 44C4. In each of the guide portions 44C3 and 44C4, the two ribs 47A protruding from the column 45 in a direction opposite to the vehicle-width direction are integrally formed with the upstanding walls 53. For example, in the guide portion 44L1, the upstanding walls 53 extend to the front, the rear, and the right of the guide portion 44L1. Thus, in the guide portion 44L1, the ribs 47A protruding from the column 45 to the front, the rear, and the right of the guide portion 44L1 are integrated into the upstanding walls 53.

A mounting hole 46 for mounting the storage 60 is formed in each of the guide portions 44. The mounting hole 46 is open in the lower surface of the guide portion 44. Here, the mounting hole 46 is formed in the column 45. The mounting hole 46 is open in the lower surface of the column 45. For example, a diameter of the mounting hole 46 may be approximately a half of a diameter of the column 45.

The mounting hole 46 is a hole for mounting a mounting component 80, also referred to as a mounting part 80, to be used for mounting the storage 60. A female screw need not be formed in the mounting hole 46 in a state prior to mounting of the storage 60. The guide portion 44 is made of, for example, a resin, and the mounting component 80 may include a fastening component harder than the guide portion 44. The fastening component may be, for example, a tapping screw 81 made of a metal. For example, when the tapping screw 81 is fastened to the mounting hole 46, a female screw or threads may be formed in an inner surface of the mounting hole 46.

An upper portion of the mounting hole 46 is closed by the upper surface 41 of the roof 40. For example, the roof 40 in the upper portion of the mounting hole 46 may be as thick as the roof 40 in the main surface 43.

The guide portion 44 need not include the rib 47, and may consist of the column 45. Here, a lower portion of the column 45 may be shaped into, for example, a circular truncated cone. The column 45 may be formed into a shape obtained by rotating the rib 47 in FIG. 7 around the central axis of the mounting hole 46.

The guide portion 44C3 connected to the upstanding walls 53 can be regarded as a lower portion of the upstanding walls 53 to which the guide portion 44 is connected. Here, a portion corresponding to the lower portions 49 of the ribs 47 is the guide portion 44, and portions corresponding to the upper portions 48 are the upstanding walls 53. In this case, the upper portion of the mounting hole 46 extends up to the upstanding wall 53.

Here, the storage 60 is mounted on the roof 40 through a plate member 62. This plate member 62 is also referred to as an upper panel portion. The vehicle 10 includes the plate members 62. The plate members 62 are plate-like components horizontally spreading. The plate members 62 overlap a lower portion of the roof 40. As illustrated in FIG. 5, a through hole 66 is formed in the plate member 62 along the vertical direction. The guide portion 44 guides the through hole 66. The lower end of the guide portion 44 is disposed inside the through hole 66.

Here, the plate member 62 includes a center plate portion 63, a left plate portion 64, and a right plate portion 65. The center guide portions 44C1 to 44C6 guide the center plate portion 63. The left guide portions 44L1 and 44L2 guide the left plate portion 64. The right guide portions 44R1 and 44R2 guide the right plate portion 65.

Here, the center plate portion 63, the left plate portion 64, and the right plate portion 65 are separate members. The area of the center plate portion 63 is larger than each area of the left plate portion 64 and the right plate portion 65 in a bottom view. The area of the center plate portion 63 is larger than a sum of the area of the left plate portion 64 and the area of the right plate portion 65. The area of the left plate portion 64 is identical to the area of the right plate portion 65. The center plate portion 63 is longer than the left plate portion 64 and the right plate portion 65 in the forward and backward direction. The center plate portion 63 is longer than the left plate portion 64 and the right plate portion 65 in the lateral direction.

Here, the plate member 62 is incorporated into the storage 60. In this case, the plate member 62 can be regarded as a part of the storage 60. The storage 60 includes the plate member 62 and a storage main body 70, also referred to a lower component 70. The storage main body 70 overlaps a lower portion of the plate member 62. Through holes 71 are also formed in the storage main body 70 at positions corresponding to the through holes 66 of the plate member 62. The plate member 62 may be fixed to the storage main body 70 via fixing means different from mountings into the mounting holes 46. The plate member 62 need not be incorporated into the storage 60. The plate member may be mounted on the roof, separately from the storage.

The through holes 66 and 71 of the storage 60 are larger than the guide portion 44. This facilitates guiding the through holes 66 and 71 to the guide portion 44. The upstanding walls 53 of the roof 40 press the peripheries of the through holes 66 and 71 in the storage 60 from above. This can prevent the through holes 66 and 71 from reaching the upper end of the guide portion 44. In each of the center guide portions 44C1 and 44C2, the upstanding wall 53 at a position away from the guide portion 44 presses the storage 60 from above as illustrated in FIG. 7. In each of the other center guide portions 44, the upstanding walls 53 integrated with the guide portion 44 can press the storage 60 from above as illustrated in FIG. 9.

The storages 60 are mounted to the roof 40 through the mounting components 80. In the example illustrated in FIG. 7, the mounting component 80 includes the tapping screw 81 and a washer 82. A hole through which a bolt of the tapping screw 81 passes is formed in the washer 82. The diameter of the hole is identical to or smaller than that of the column 45. An outside diameter of the washer 82 is larger than each of the through holes 66 and 71 of the storage 60. The outer edge of the washer 82 presses the storage 60 from the bottom. The head of the tapping screw 81 presses the washer 82 from the bottom.

The head of each of the mounting components 80 may be or need not be exposed to the occupant space. The mounting components 80 may include the mounting part 80 whose head is exposed. The mounting components 80 may include the mounting part 80 whose head is not exposed. The mounting components 80 may include both of the mounting part 80 whose head is exposed and the mounting part 80 whose head is not exposed. All of the heads of the mounting components 80 need not be exposed. All of the heads of the mounting components 80 may be exposed.

For example, the heads of the mounting components 80 to be mounted to the four center guide portions 44C1, 44C2, 44C4, and 44C6, the two left guide portions 44L1 and 44L2, and the two right guide portions 44R1 and 44R2 may be exposed. The heads of the mounting components 80 to be mounted to the two center guide portions 44C3 and 44C5 may be hidden by the storage main body 70. The heads of the mounting components 80 to be mounted to the two center guide portions 44C3 and 44C5 may be disposed inside the pockets and hidden by the separation portions 73.

As illustrated in FIG. 8, the lower end of the center guide portion 44C3 is located below that of the left guide portion 44L2 along the vehicle-width direction. The lower end of the right guide portion 44R2 is identical in height to that of the left guide portion 44L2. Thus, the lower end of the center guide portion 44C3 is located below that of the right guide portion 44R2.

The guide portion 44 includes a first guide portion, and a second guide portion with a lower end different in height from that of the first guide portion. The center guide portion 44C3 is an example of the first guide portion, and the left guide portion 44L2 and the right guide portion 44R2 are examples of the second guide portion.

The division of the center plate portion 63, the left plate portion 64, and the right plate portion 65 in the plate member 62 facilitates disposing the plate member 62 at a height position to correspond to each of the center guide portion 44C3, the left guide portion 44L2, and the right guide portion 44R2.

The storage main body 70 is integrally formed with a region including the center plate portion 63, the left plate portion 64, and the right plate portion 65. The storage main body 70 includes a joint portion 74 across the center plate portion 63 and the left plate portion 64, and a joint portion 74 across the center plate portion 63 and the right plate portion 65. The joint portions 74 disposed with bends accommodate height differences in the vertical direction. In the storage main body 70, the joint portion 74 has flexibility which allows the joint portion 74 to be disposed with a bend from a flat state as illustrated in FIG. 8.

The upper surface 41 in the center region CR is lower than the upper surface 41 in the left region LR and the upper surface 41 in the right region RR along the vehicle-width direction. As illustrated in FIG. 8, the upper surface 41 in the center guide portion 44C3 is lower than the upper surface 41 in the left guide portion 44L2. The difference in height in the upper surface 41 causes a difference in height between the lower end of the center guide portion 44C3 and the lower end of the guide portion 44L2. The same applies to a difference in height between the lower end of the center guide portion 44C3 and the lower end of the right guide portion 44R2.

As illustrated in FIG. 8, the upper surface 41 in the center region CR is a sloped surface along the vehicle-width direction. Here, the upper surface 41 in the center region CR is a sloped surface descending outward from the center along the vehicle-width direction. In the lower surface 42 of the roof 40, the lower surface of the upstanding wall 53 in the center region CR is a horizontal plane along the vehicle-width direction. This reduces the tendency of the storage 60 to be inclined from a normal mounting attitude. The upstanding wall 53 aligns the height of the lower surface 42, without depending on the height of the upper surface 41 of the roof 40.

As illustrated in FIG. 1, the attitude of the roof 40 mounted on the vehicle 10 may be an attitude in which the front end descends more than the rear end. Here, while the roof 40 is mounted on the vehicle 10, the lower surfaces of the storages 60 and the upstanding walls 53 extending along the forward and backward direction may also have an attitude in which the front descends more than the rear. When the roof 40 is in a horizontal attitude prior to being mounted on the vehicle 10, the lower surfaces of the storages 60 and the upstanding walls 53 extending along the forward and backward direction may be horizontal.

The storage 60 includes an upper panel portion 62 and a lower component 70. The upper panel portion 62 is guided by the roof 40 and mounted on the roof 40. The lower component 70 includes the bonding portion 72 to be mounted on the upper panel portion 62, and the separation portions 73 spaced from the upper panel portion 62 in the vertical direction. Here, the plate member 62 is an example of the upper panel portion 62, and the storage main body 70 is an example of the lower component 70. Since the upper panel portion 62 is formed separately from the lower component 70, the upper panel is easily mounted on the roof 40. Formation of the upper panel portion 62 and the lower component 70 as separate structures facilitates formation of the space in the storage 60. The upper panel portion 62 and the separation portions 73 may have an integral structure or separate structures.

The plate member 62 may be formed separately from a storage. Here, the storage main body 70 can be regarded as a storage.

The guide portions 44 may guide the roof accessories. The roof 40 may include guide portions that guide the roof accessories. The roof accessories may be components except the storages 60. Examples of the roof accessories except the storages 60 may include a main body of electrical equipment such as an audio product or a light, and brackets for mounting the main body of the electrical equipment. The examples may include color panels for design.

A portion in which the upstanding wall 53 is integrated with the guide portion 44 can be regarded as a portion in which a mount, also referred to as a fixing part (the mounting hole 46) for fixing a roof accessory to the upstanding wall 53 is formed.

In the roof 40 with the aforementioned structure and the vehicle 10 including the roof 40, the lower surface 42 of the roof 40 includes the main surface 43, and the guide portion 44 that protrudes downward from the main surface 43 and guides the storage 60. This facilitates mounting the storage 60 to the lower surface 42 of the roof 40.

As illustrated in FIG. 7, the guide portion 44 has a shape in which the horizontal cross section decreases toward the lower end. This facilitates passing the guide portion 44 through a hole formed in, for example, the storage 60.

Furthermore, the guide portion 44 includes the column 45 and the at least one rib 47 laterally protruding from the external surface of the column 45 as illustrated in FIG. 5, etc. This facilitates guiding the storage 60 to the guide portion 44, using the rib 47 as a beacon or locator.

Furthermore, the at least one rib 47 includes the ribs 47 radially disposed with respect to the column 45 as illustrated in FIG. 5, etc. This facilitates guiding the storage 60 to the guide portion 44, using the ribs 47 as more outstanding beacons or locators.

Furthermore, the at least one rib 47 has a shape in which a protruding dimension of a portion from the column 45 toward the lower end (the lower portion 49) decreases as illustrated in FIG. 7, etc. The portion is located closer to an upper end than to the lower end of the rib 47. This facilitates passing the guide portion 44 through the through holes 66 and 71 formed in, for example, the storage 60.

The mounting hole 46 for mounting the storage 60 is formed in the column 45, and the mounting hole 46 is open in the lower surface of the column 45 as illustrated in FIG. 5, etc. This can mount the storage 60 to the guide portion 44.

Furthermore, an upper portion of the mounting hole 46 is closed by the upper surface 41 of the roof 40 as illustrated in FIG. 7, etc. This can prevent water on the upper surface 41 of the roof 40 from entering the lower surface 42 through the mounting hole 46.

Furthermore, the guide portion 44 includes the left guide portions 44L1 and 44L2 disposed in the left region LR with respect to the center region CR along the vehicle-width direction, and the right guide portions 44R1 and 44R2 disposed in the right region RR with respect to the center region CR along the vehicle-width direction as illustrated in FIG. 3, etc. This can guide the storage 60 at both sides in the vehicle-width direction.

Furthermore, the guide portion 44 includes the center guide portions 44C1 to 44C6 disposed in the center region CR along the vehicle-width direction as illustrated in FIG. 3, etc. This can guide the storage 60 in the center in the vehicle-width direction.

Furthermore, the lower ends of the center guide portions 44C1 to 44C6 are located below those of the left guide portions 44L1 and 44L2 and the right guide portions 44R1 and 44R2 as illustrated in FIG. 8, etc. This facilitates guiding the center in the vehicle-width direction earlier.

Furthermore, the guide portion 44 includes the first guide portion 44C3, and the second guide portion 44L2 with a lower end different in height from that of the first guide portion 44C3 as illustrated in FIG. 8, etc. This can mount the storage 60 at different mounting heights. For example, the storage 60 can be mounted at positions corresponding to depressions and protrusions of the roof 40. A part of the storage 60 is divided according to the height positions.

Furthermore, the mounting hole 46 for mounting the storage 60 is formed in the guide portion 44, and the mounting hole 46 is open in the lower surface of the guide portion 44 as illustrated in FIG. 5, etc. This can mount the storage 60 to the guide portion 44.

The vehicle includes the storage 60 supported by the roof 40, and the storage 60 includes the upper panel portion 62 guided by the roof 40 and mounted on the roof 40, and the separation portions 73 spaced from the upper panel portion 62 in the vertical direction as illustrated in FIG. 9, etc. This can form the storage 60 between the separation portions 73 and the upper panel portion 62. Formation of the space in the storage 60 below the upper panel portion 62 can prevent interference between the lower surface 42 of the roof 40 and an object when a bag is taken in and out.

Furthermore, the roof 40 includes the roof panel 50, and the upstanding wall 53 that protrudes downward from the roof panel 50 and extends in the horizontal direction, and the guide portion 44 is connected to a lower portion of the upstanding wall 53 as illustrated in FIG. 6, etc. This can dispose the storage 60 such that the storage 60 abuts the lower surface of the upstanding wall 53. This can increase the stiffness of the roof panel 50. In addition, even when the roof panel 50 has depressions and protrusions, alignment of the positions of the lower surfaces of the upstanding walls 53 facilitates fixing the storages 60.

Furthermore, the mounting hole 46 for mounting the storage 60 is formed in the guide portion 44, a lower portion of the mounting hole 46 is open in the lower surface of the guide portion 44, and the upper portion of the mounting hole 46 extends up to the upstanding wall 53 as illustrated in FIG. 9, etc. This can lengthen the mounting hole 46 and increase the mounting strength.

The lower surface 42 includes the main surface 43, and the guide portion 44 that protrudes downward from the main surface 43 and guides a roof accessory. The guide portion 44 facilitates disposing the roof accessory in the roof 40.

Furthermore, the roof 40 includes the roof panel 50, the upstanding wall 53 that protrudes downward from the roof panel 50 and extends in the horizontal direction, and the fixing part 46, also referred to as mounting hole 46, disposed in a part of the upstanding wall 53 and fixing the roof accessory. This facilitates disposing the roof accessory along the upstanding wall 53, regardless of the shape of the roof panel 50.

### Appendixes

The vehicle 10 may be a passenger transport vehicle. The passenger transport vehicle is a vehicle designed to travel at low speeds within a limited area. Examples of the limited area include limited community areas, and private roads and private lands (e.g., golf courses and parks) except public roads. The limited community areas may be areas provided for use by community residents. The community areas are, for example, areas including houses and public facilities (e.g., schools and hospitals), and are areas in which the passenger transport vehicles designed to travel through non-public highways are permitted to travel at low speeds. The low speeds are, for example, speeds with upper limits ranging from 20 mph to 30 mph. The passenger transport vehicles include personal transport vehicles (PTVs) in accordance with ANSI/ILTVA Z135, and golf carts in accordance with ANSI/ILTVA Z130.1. Furthermore, the passenger transport vehicles include personal transportation electric vehicles.

Passenger transport vehicles may be, for example, versatile small vehicles suitable for traveling through limited off-road areas rather than traveling through public roads at fast speeds. Off-road vehicles may be, for example, side-by-side vehicles. The side-by-side vehicles are, for example, small vehicles suitable for all terrain travel, particularly, off-road travel, and vehicles in which occupants can be seated side by side. The side-by-side vehicles may be, for example, multipurpose off-highway utility vehicles (MOHUVs) defined by ANSI/OPEI B71.9-2016, and recreational off-highway vehicles defined by ANSI/ROHVA 1-2016.

This application discloses the following aspects.

A first aspect is a vehicle comprising: a pillar extending upward in a vehicle body; and a roof supported at a top of the pillar, the roof including an upper surface and a lower surface, the lower surface of the roof including a main surface, and a guide portion that protrudes downward from the main surface and guides a storage, wherein the guide portion has a shape in which a horizontal cross section varies at least in part.

In this vehicle, the guide portion facilitates mounting the storage to the lower surface of the roof.

A second aspect is the vehicle according to the first aspect, wherein the guide portion has a shape in which the horizontal cross section decreases toward a lower end.

This facilitates passing the guide portion through the hole formed in, for example, the storage.

A third aspect is the vehicle according to the first or the second aspect, wherein the guide portion includes a column, and at least one rib laterally protruding from an external surface of the column.

This facilitates guiding the storage to the guide portion, using the rib as a beacon.

A fourth aspect is the vehicle according to the third aspect, wherein the at least one rib includes ribs radially disposed with respect to the column.

This facilitates guiding the storage to the guide portion, using the ribs as more outstanding beacons.

A fifth aspect is the vehicle according to the third or the fourth aspect, wherein the at least one rib has a shape in which a protruding dimension of a portion from the column toward a lower end decreases, the portion being located closer to an upper end than to the lower end.

This facilitates passing the guide portion through the hole formed in, for example, the storage.

A sixth aspect is the vehicle according to any one of the third to fifth aspects, wherein a mounting hole for mounting the storage is formed in the column, and the mounting hole is open in a lower surface of the column.

This can mount the storage to the guide portion.

A seventh aspect is the vehicle according to the sixth aspect, wherein an upper portion of the mounting hole is closed by the upper surface.

This can prevent water on the upper surface of the roof from entering the lower surface through the mounting hole.

An eighth aspect is the vehicle according to any one of the first to seventh aspects, wherein the guide portion includes a left guide portion disposed in a left region with respect to a center region along a vehicle-width direction, and a right guide portion disposed in a right region with respect to the center region along the vehicle-width direction.

This can guide the storage at both sides in the vehicle-width direction.

A ninth aspect is the vehicle according to the eighth aspect, wherein the guide portion includes a center guide portion disposed in the center region along the vehicle-width direction.

This can guide the storage in the center in the vehicle-width direction.

A tenth aspect is the vehicle according to the ninth aspect, wherein a lower end of the center guide portion is located below a lower end of the left guide portion and a lower end of the right guide portion.

This facilitates guiding the center in the vehicle-width direction earlier.

An eleventh aspect is the vehicle according to the tenth aspect, wherein the upper surface in the center region is lower than the upper surface in the left region and the upper surface in the right region along the vehicle-width direction.

A twelfth aspect is the vehicle according to any one of the first to eleventh aspects, wherein the guide portion includes a first guide portion, and a second guide portion with a lower end different in height from a lower end of the first guide portion.

This can mount the storage at different mounting heights. For example, the storage can be mounted at positions corresponding to depressions and protrusions of the roof. A storage plate is divided according to the height positions.

A thirteenth aspect is the vehicle according to any one of the first to twelfth aspects, wherein a mounting hole for mounting the storage is formed in the guide portion, and the mounting hole is open in a lower surface of the guide portion.

This can mount the storage to the guide portion.

A fourteenth aspect is the vehicle according to any one of the first to thirteenth aspects, the vehicle comprising a plate member overlapping a lower portion of the roof, wherein a through hole is formed in the plate member along a vertical direction, and a lower end of the guide portion is disposed inside the through hole.

A fifteenth aspect is the vehicle according to any one of the first to fourteenth aspects, the vehicle comprising a first seat supported by the vehicle body, and a second seat located behind the first seat and supported by the vehicle body, wherein the guide portion includes a first-seat guide portion guiding a first-seat storage, and a second-seat guide portion guiding a second-seat storage.

A sixteenth aspect is the vehicle according to any one of the first to fifteenth aspects, the vehicle comprising the storage supported by the roof, the storage including an upper panel portion guided by the roof and mounted on the roof, and a separation portion spaced from the upper panel portion in a vertical direction.

This can form the storage between the separation portion and the upper panel portion. Formation of the space in the storage below the upper panel portion can prevent interference between the lower surface of the roof and an object when a bag is taken in and out.

A seventeenth aspect is the vehicle according to any one of the first to sixteenth aspects, wherein the roof includes a roof panel, and an upstanding wall that protrudes downward from the roof panel and extends in a horizontal direction, and the guide portion is connected to a lower portion of the upstanding wall.

This can dispose the storage such that the storage abuts the lower surface of the upstanding wall. This can increase the stiffness of the roof panel. In addition, even when the roof panel has depressions and protrusions, alignment of the positions of the lower surfaces of the upstanding walls facilitates fixing the storages.

An eighteenth aspect is the vehicle according to the seventeenth aspect, wherein a mounting hole for mounting the storage is formed in the guide portion, a lower portion of the mounting hole is open in a lower surface of the guide portion, and an upper portion of the mounting hole extends up to the upstanding wall.

This can lengthen the mounting hole and increase the mounting strength.

A nineteenth aspect is a roof to be mounted on a vehicle, the roof comprising an upper surface and a lower surface, the lower surface including a main surface, and a positioning portion protruding downward from the main surface, the positioning portion positioning a roof accessory to be mounted to the roof.

In this roof, the guide portion facilitates disposing the roof accessory.

A twentieth aspect is a vehicle comprising: a pillar extending upward in a vehicle body; and a roof supported at a top of the pillar, the roof including a roof panel, an upstanding wall that protrudes downward from the roof panel and extends in a horizontal direction, and a fixing part disposed in a part of the upstanding wall and fixing a roof accessory.

In this vehicle, the roof accessory is easily disposed along the upstanding wall, regardless of the shape of the roof panel.

The foregoing description is in all aspects illustrative and does not restrict this invention. Numerous modifications and variations that have not yet been exemplified are devised without departing from the scope of this invention.

What is claimed is:

1. A vehicle, comprising:
a pillar extending upward in a vehicle body;
a locator; and
a roof supported at a top of the pillar, the roof including an upper surface and a lower surface, the lower surface of the roof including a main surface,
wherein:
the locator protrudes downward from the main surface and locates a storage, and
the locator has a shape in which a horizontal cross section varies at least in part.

2. The vehicle according to claim 1, wherein:
the locator has a shape in which the horizontal cross section decreases toward a lower end.

3. The vehicle according to claim 1, wherein:
the locator includes a column, and at least one rib laterally protruding from an external surface of the column.

4. The vehicle according to claim 3, wherein:
the at least one rib includes ribs radially disposed with respect to the column.

5. The vehicle according to claim 3, wherein:
the at least one rib has a shape in which a protruding dimension of a portion from the column toward a lower end decreases, the portion being located closer to an upper end than to the lower end.

6. The vehicle according to claim 3, wherein:
the column includes a mounting hole for mounting the storage, and
the mounting hole is open in a lower surface of the column.

7. The vehicle according to claim 6, wherein:
an upper portion of the mounting hole is closed by the upper surface.

8. The vehicle according to claim 1, wherein the locator includes:
a left guide portion disposed in a left region with respect to a center region along a vehicle-width direction, and
a right guide portion disposed in a right region with respect to the center region along the vehicle-width direction.

9. The vehicle according to claim 8, wherein:
the locator includes a center guide portion disposed in the center region along the vehicle-width direction.

10. The vehicle according to claim 9, wherein:
a lower end of the center guide portion is located below a lower end of the left guide portion and a lower end of the right guide portion.

11. The vehicle according to claim 10, wherein:
the upper surface in the center region is lower than the upper surface in the left region and the upper surface in the right region along the vehicle-width direction.

12. The vehicle according to claim 1, wherein the guide portion includes:
a first guide portion, and
a second guide portion with a lower end different in height from a lower end of the first guide portion.

13. The vehicle according to claim 1, wherein:
the locator includes a mounting hole for mounting the storage, and
the mounting hole is open in a lower surface of the guide portion.

14. The vehicle according to claim 1, comprising
a plate overlapping a lower portion of the roof,
wherein:
the plate includes a through hole along a vertical direction, and
a lower end of the guide is disposed inside the through hole.

15. The vehicle according to claim 1, further comprising:
a first seat supported by the vehicle body; and
a second seat located behind the first seat and supported by the vehicle body,
wherein the locator includes a first-seat guide portion to locate a first-seat storage, and a second-seat guide portion to locate a second-seat storage.

16. The vehicle according to claim 1, further comprising:
the storage supported by the roof, the storage including an upper panel guided by the roof and mounted to the roof, and a separator portion spaced from the upper panel portion in a vertical direction.

17. The vehicle according to claim 1, wherein:
the roof includes a roof panel and an upstanding wall that protrudes downward from the roof panel and extends in a horizontal direction, and
the guide portion is connected to a lower portion of the upstanding wall.

18. The vehicle according to claim 17, wherein:
the guide includes a mounting hole for mounting the storage,
a lower portion of the mounting hole is open in a lower surface of the guide, and
an upper portion of the mounting hole extends up to the upstanding wall.

19. A roof to be mounted on a vehicle, the roof comprising:
an upper surface and a lower surface,
the lower surface including a main surface and a locator protruding downward from the main surface, the locator to position a roof accessory to be mounted to the roof.

20. A vehicle, comprising:
a pillar extending upward in a vehicle body; and
a roof supported at a top of the pillar, the roof including a roof panel, an upstanding wall that protrudes downward from the roof panel and extends in a horizontal direction, and a mount disposed at the upstanding wall to which a roof accessory is to be mounted.
